(19) United States
(12) Patent Application Publication
(10) Pub. No.: US 2010/0150552 A1
(43) Pub. Date: Jun. 17, 2010

(54) OPTICAL/ELECTRICAL COMPOSITE CABLE, OPTICAL/ELECTRICAL COMPOSITE CABLE CONNECTION DEVICE AND OPTICAL/ELECTRICAL COMPOSITE CABLE DRIVE METHOD

(76) Inventor: Hideto FURUYAMA, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/562,451

(22) Filed: Sep. 18, 2009

(30) Foreign Application Priority Data
Dec. 12, 2008 (JP) 2008-317004

(51) Int. Cl. H04B 10/08; H04B 10/12

(52) U.S. Cl. 398/38; 398/141

(57) ABSTRACT

An optical/electrical composite cable in which a first connector having an optical transmission unit is connected to a second connector having an optical reception unit via an electrical wire and an optical wiring line includes a state detection unit that detects a connection state of the first connector, a connection state of the second connector, a power supply state of a transmission-side electronic device connected to the first connector and a power supply state of a reception-side electronic device connected to the second connector, and an electrical power supply control unit that controls supply of electrical power to the optical transmission unit and optical reception unit according to the detected states.

### CROSS-REFERENCE TO RELATED APPLICATIONS

This application is based upon and claims the benefit of priority from prior Japanese Patent Application No. 2008-317004, filed Dec. 12, 2008, the entire contents of which are incorporated herein by reference.

### BACKGROUND

Recently, an attempt is made to dramatically enhance the operating speeds of LSIs as the performances of electronic devices such as bipolar transistors and field effect transistors are enhanced. With the enhancement, a problem of erroneous operation due to electromagnetic noise and the limitation in the operating speed of electrical wires used for connection between electronic devices occurs. Particularly, improvement of the definition of a display device and an increase in the amount of video data make the above problem more significant. In order to cope with the wiring problem, some optical wiring devices that transmit signals by means of light are proposed.

### SUMMARY

According to one aspect of this invention, there is provided an optical/electrical composite cable drive method for driving an optical/electrical composite cable in which a first connector having an optical transmission unit is connected to a second connector having an optical reception unit by an electrical wire and optical wiring line, the method comprising detecting a connection state of the first connector, a connection state of the second connector, a power supply state of a transmission-side electronic device that is coupled with the first connector and a power supply state of a reception-side electronic device that is coupled with the second connector; and controlling supply of electrical power to the optical transmission unit and optical reception unit according to the detected connection states and power supply states of the respective electronic devices.

According to another aspect of this invention, there is provided an optical/electrical composite cable comprising a first connector having an optical transmission unit; a second connector having an optical reception unit; an electrical wire connected between the first and second connectors; an optical wiring line connected between the first and second connectors; a state detection unit that detects a connection state of the first connector, a connection state of the second connector, a power supply state of a transmission-side electronic device that is coupled with the first connector and a power supply state of a reception-side electronic device that is coupled with the second connector; and an electrical power supply control unit that controls supply of electrical power to the optical transmission unit and optical reception unit according to the states detected by the detection unit.

According to another aspect of this invention, there is provided an optical/electrical composite cable connection device including a data transmitter that outputs an electrical signal; a data receiver that inputs an electrical signal; at least one data relay unit inserted between the data transmitter and the data receiver; and a plurality of optical/electrical composite cables that respectively connect adjacent ones of the data transmitter, data receiver and relay unit, wherein each of the optical/electrical composite cables includes a first connector having an optical transmission unit, a second connector having an optical reception unit, an electrical wire connected between the first and second connectors, an optical wiring line connected between the first and second connectors, a state detection unit that detects a connection state of the first connector, a connection state of the second connector, a power supply state of a transmission-side device that is coupled with the first connector and a power supply state of a reception-side device that is coupled with the second connector, and an electrical power supply control unit that controls supply of electrical power to the optical transmission unit and optical reception unit according to the states detected by the detection unit.

### BRIEF DESCRIPTION OF THE DRAWING

FIG. 1 is a schematic configuration view showing an optical/electrical composite cable according to a first embodiment.

FIG. 2 is a flowchart for illustrating the basic operation of the first embodiment.

FIG. 3 is a block diagram showing an optical/electrical composite cable connection device according to a second embodiment.

FIG. 4 is a block diagram showing an optical/electrical composite cable connection device according to a third embodiment.

### DETAILED DESCRIPTION OF THE INVENTION

Embodiments of the present invention will be described below with reference to the accompanying drawings. The explanation is made by taking several concrete configurations as examples, but configurations that have the same functions can be realized in a similar fashion and this invention is not limited to the embodiments described below.

In data transmission using optical wires, it is necessary to provide power sources of optical interfaces of a light-emitting element and light-receiving element on both of the transmission side and reception side, respectively. At this time, electrical power is wastefully used and the lifetime of the optical interface will be reduced more than necessary if the adequate control operation therefore is not performed. That is, the standby state occurs while the optical interface is set in an operative state even if the power source of one of the electronic devices used is set in the OFF state. Therefore, in an extreme case, there may occur a possibility that only the optical interface will be degraded even when the electronic device is scarcely used.

Conversely, as is described in JP-A 2004-350155 (KOKAI), an optical communication system in which the power source of an optical device is turned on only when connection between the electronic devices is correctly made is proposed. However, the system detects removal or breakage of the optical fiber cable to control light emission from the optical device in the optical communication device and is not used to prevent the above deterioration of an optical interface of an optical/electrical composite cable containing the optical interface.

### First Embodiment

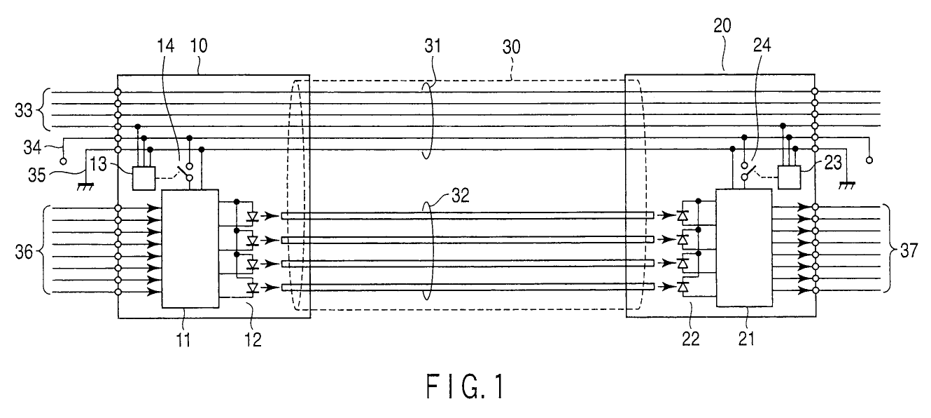

FIG. 1 is a schematic configuration view showing an optical/electrical composite cable according to a first embodiment.

In FIG. 1, a symbol 10 indicates a transmission-side connector (first connector) detachably attached to a data transmitter (transmission-side electronic device) and 20 a reception-side connector (second connector) detachably attached to a data receiver (reception-side electronic device). A plurality of electrical wires 31 and a plurality of optical wiring lines 32 are connected between the connectors 10 and 20. The electrical wires 31 and optical wiring lines 32 connected between the connectors 10 and 20 are shielded by a cable-coating member 30. The electrical wires 31 are provided to continuously extend from the device connection terminals of the connector 10 to the device connection terminals of the connector 20.

The transmission-side connector 10 has terminals connected to a plurality of lines 33, 34, 35, 36 of the data transmitter. The lines 33 are control lines, the line 34 is a power supply line, the line 35 is a ground line and the lines 36 are high-speed signal lines. The terminals connected to the control lines 33, power supply line 34 and ground line 35 are connected to the electrical wirings 31.

In the transmission-side connector 10, an optical transmission unit 11, light-emitting element 12, first optical link control unit (detection unit) 13 and first optical link switch (interruption unit) 14 are provided. The input port of the optical transmission unit 11 is connected to terminals of the high-speed signal lines 36 and the output port thereof is connected to the light-emitting element 12. An electrical signal obtained via the high-speed signal lines 36 is converted into a light signal by means of the light-emitting element 12 and the thus converted light signal is transmitted to the optical wiring lines 32. Further, the optical transmission unit 11 is connected to the power source line 34 via the switch 14 and connected to the ground line 35 for electrical power supply.

The optical link control unit 13 is connected to part of the control lines 33, power source line 34 and ground line 35 to detect the connection state of the transmission-side connector 10 to the data transmitter and detect the power-on states of the data transmitter and data receiver. The switch 14 is turned ON only when connection to the data transmitter is correctly made and the power-on states of the data transmitter and data receiver are detected.

Like the transmission-side connector 10, the reception-side connector 20 has terminals connected to the plural lines 33, 34, 35 of the data receiver and terminals connected to high-speed signal lines 37 of the data receiver.

In the reception-side connector 20, an optical reception unit 21, light-receiving element 22, second optical link control unit (detection unit) 23 and second optical link switch (power supply unit) 24 are provided. The input port of the optical reception unit 21 is connected to the light-receiving element 22 to which the optical wiring lines 32 are optically connected. A light signal obtained via the optical wiring lines 32 is converted into an electrical signal by means of the light-receiving element 22 and the thus converted electrical signal is transmitted to the terminals of the high-speed signal lines 37. Further, the optical reception unit 21 is connected to the power source line 34 via the switch 24 and connected to the ground line 35 for electrical power supply.

The optical link control unit 23 is connected to part of the control lines 33, power source line 34 and ground line 35 to detect the connection state of the reception-side connector 20 to the data receiver and detect the power-on states of the data transmitter and data receiver. The switch 24 is turned ON only when connection to the data receiver is correctly made and the power-on states of the data transmitter and data receiver are detected.

In this embodiment, the first optical link control unit 13 is provided in the transmission-side connector 10 and the second optical link control unit 23 is provided in the reception-side connector 20. However, it is possible to provide the functions of the above units in one of the control units. That is, one of the control units may turn ON both of the switches 14, 24 when it is detected that connection to the data transmitter and data receiver is correctly made and both of the power sources of the data transmitter and data receiver are set in the turn-on state.

Further, it is not always required to independently form the devices 11 to 14 in the transmission-side connector 10 and they can be formed in one chip. Likewise, the devices 21 to 24 in the reception-side connector 20 may be formed in one chip.

Next, the operation of the optical/electrical composite cable with the above configuration is explained.

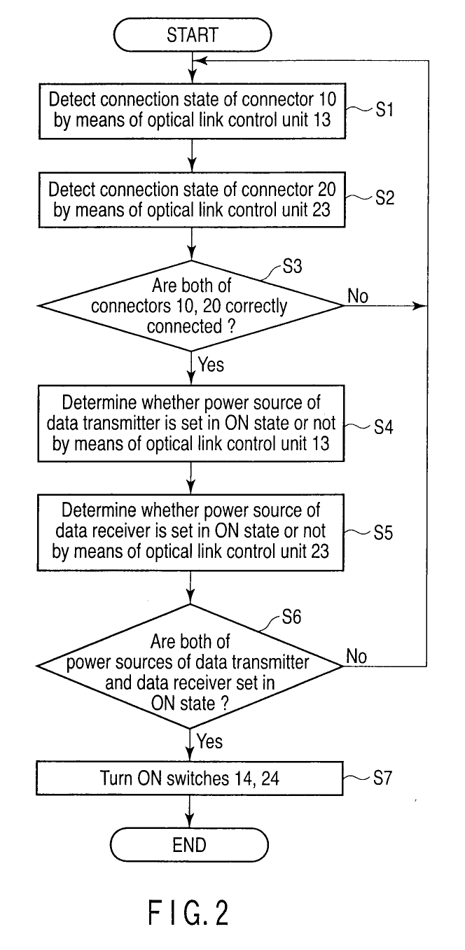

FIG. 2 is a flowchart for illustrating the basic operation of the first embodiment. First, whether the connector 10 is properly connected or not is detected by the optical link control unit 13 (step S1) and whether the connector 20 is properly connected or not is detected by the optical link control unit 23 (step S2). Steps S1, S2 can be performed in an opposite order or can be simultaneously performed. Then, whether the connectors 10, 20 are connected (the transmission-side connector 10 is connected to the data transmitter and the reception-side connector 20 is connected to the data receiver) or not is determined (step S3). If it is determined that they are properly connected, whether the power source of the data transmitter is turned on or not is determined by the optical link control unit 13 (step S4). Further, if the power source of the data receiver is turned on or not is determined by the optical link control unit 23 (step S5). Steps S4, S5 can be performed in an opposite order or can be simultaneously performed. Then, whether both of the power sources of the data transmitter and data receiver are turned on or not is determined (step S6). If it is determined in step S6 that the power sources are turned on, the switches 14, 24 are turned ON (step S7).

Conversely, if it is determined in step S3 that the connectors are not properly connected, the switches 14, 24 are kept in the OFF state. Further, if it is determined in step S6 that the power sources are not turned on, the switches 14, 24 are kept in the OFF state. The above operation is explained in more detail.

When the optical/electrical composite cable is set in a disconnected state with respect to the data transmitter and data receiver, the switches 14, 24 are kept in the OFF state. It is now supposed that the data transmitter is connected to the transmission-side connector 10 and the data receiver is connected to the reception-side connector 20.

The optical link control unit 13 detects attachment of the optical/electrical composite cable itself to the data transmitter and detects whether the power sources of the data transmitter and data receiver are turned on or not by means of the electrical wires 31 (control lines). As a result, if it is determined that the optical/electrical composite cable is properly connected and the power sources of the data transmitter and data receiver are correctly turned on, the switch 14 is turned ON. Conversely, if it is determined that the optical/electrical composite cable is not correctly attached or one of the power sources of the data transmitter and data receiver is not turned on, the switch 14 is kept in the OFF state.

In this case, in order to detect the connection state of the data transmitter by means of the optical link control unit 13, for example, device information transmitted from the data transmitter may be detected by means of one of the control lines 33. Further, a switch whose ON/OFF state is changed according to the lock state is provided in a mechanical lock mechanism provided in the transmission-side connector 10 and the ON/OFF state of the switch may be detected to detect the connection state. As another method, a signal may be transmitted from the data transmitter to one line (A) of the control lines 33, the line A may be connected to a different line (B) of the control lines 33 in the data receiver and a signal of the line B may be detected by means of the optical link control unit 13. That is, whether both of the data transmitter and data receiver are properly connected or not can be determined by detecting an electrical loop of the control lines 33.

The optical link control unit 23 detects attachment of the optical/electrical composite cable itself to the data receiver and detects whether the power sources of the data transmitter and data receiver are turned on or not by means of the electrical wires 31 (control lines). As a result, if it is determined that the optical/electrical composite cable is properly connected and the power sources of the data transmitter and data receiver are correctly turned on, the switch 24 is turned ON. Conversely, if it is determined that the optical/electrical composite cable is not correctly attached or one of the power sources of the data transmitter and data receiver is not turned on, the switch 24 is kept in the OFF state.

In order to detect the connection state of the data receiver by means of the optical link control unit 23, for example, device information transmitted from the data receiver may be detected by means of one of the control lines 33 like the case of the optical link control unit 13. Further, like the case of the optical link control unit 13, the lock state of the device or an electrical loop of the control lines may be detected.

In order to detect the power-on states of the data transmitter and data receiver by means of the optical link control units 13, 23, device detection may be performed together with voltage detection of the power source line 34. That is, if both of the devices of the data transmitter and data receiver are detected together with voltage detection of the power source line 34 by means of the optical link control units 13, 23, the switches 14, 24 are turned ON. As a result, electrical power is supplied to the optical transmission unit 11 and optical reception unit 21 only when the transmission-side connector 10 is properly connected to the data transmitter, the reception-side connector 20 is properly connected to the data receiver and the power-on states of both of the power sources of the above devices are detected.

With the above functional configuration, in a case wherein data transmission is not required, for example, in a case wherein only a video recording device used as the data transmitter is independently operated to perform a programmed recording operation, it becomes possible to prevent an optical link (optical transmission unit 11 and optical reception unit 21) from being set into an operative state even though the link operation with respect to a display device used as the data reception unit is not required. As a result, unnecessary electrical power consumption can be suppressed and it can be prevented that active elements (light-emitting element 12 and light-receiving element 22) of the optical link unit are operated at the inoperative time to reduce the actual operation time of the optical/electrical composite cable.

It is desirable to determine that detection of attachment of the optical/electrical composite cable itself to the corresponding device is abnormal in a case wherein the reception-side connector 20 is connected to the data transmitter or in a case wherein the transmission-side connector 10 is connected to the data receiver, that is, in a case wherein inverse connection is made. Further, if the inverse connection is detected, a function of displaying an alarm may be additionally provided. Of course, this is applied to a case wherein the data transmitters or data receivers are connected to each other. In this case, the inverse connection can be detected by detecting device information by means of the optical link control units 13, 23.

In the flowchart of FIG. 2, turn-on of the power source may be first confirmed and then whether connection is correctly made or not may be determined. That is, the process can be performed according to the following procedure.

First, whether the power source of the data transmitter is turned on or not is detected by the optical link control unit 13 (step S4) and whether the power source of the data receiver is turned on or not is detected by the optical link control unit 23 (step S5). Steps S4, S5 can be performed in an opposite order or can be simultaneously performed. Then, whether both of the power sources of the data transmitter and data receiver are turned on or not is determined (step S6). If it is determined that the power sources are turned on, whether the connector 10 is properly connected or not is determined by means of the optical link control unit 13 (step S1) and whether the connector 20 is properly connected or not is determined by means of the optical link control unit 23 (step S2). Steps S1, S2 can be performed in an opposite order or can be simultaneously performed. Then, whether the connectors 10, 20 are properly connected (the transmission-side connector 10 is connected to the data transmitter and the reception-side connector 20 is connected to the data receiver) or not is determined (step S3). If it is determined in step S3 that the connectors are properly connected, the switches 14, 24 are turned ON (step S7).

### Second Embodiment

The above optical/electrical composite cable has a limitation that data transmission cannot be performed if the power source of an electronic device arranged in an intermediate portion is not turned on when three or more electronic devices are connected. However, this invention is configured as follows to solve the above problem.

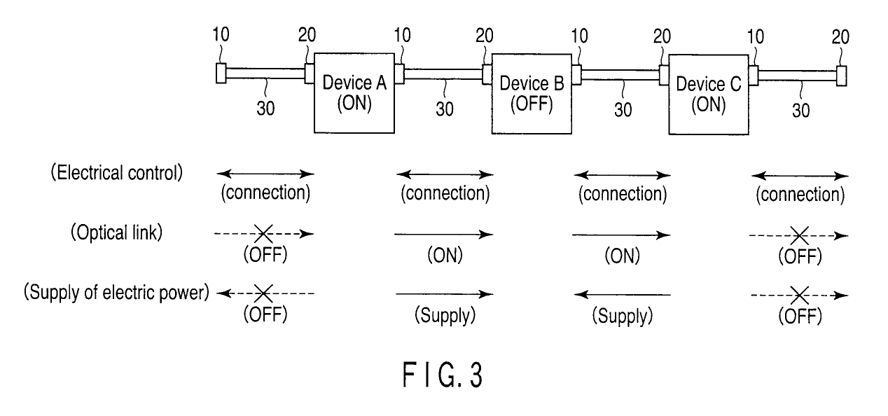

FIG. 3 is a block diagram showing an optical/electrical composite cable connection device according to a second embodiment of this invention and an example in which three data devices (A, B, C) are series-connected via optical/electrical composite cables is shown. As examples of the respective devices, the device A is an image playback device or game device, the device B is an image recording device and the device C is a display device, for example. In this example, it is supposed that image data is transmitted from the device A towards the device C.

The devices A to C are connected by means of plural optical/electrical composite cables each of which is explained in the first embodiment. A data transmission or data reception operation is performed when the power sources of the devices are turned on and the input connector and output connector with respect to the optical/electrical composite cable are electrically directly connected so as to permit a signal line and power source line to simply pass therethrough when the power sources of the devices are turned off. That is, each device can access the control line and signal line only when the power source of the device is turned on and each device is disconnected from the lines when the power source of the device is turned off. For this purpose, a method of connecting the transmission unit and reception unit of the electronic device to each optical/electrical composite cable via normally-off pass-gate transistors and short-circuiting the input terminal and output terminal of the optical/electrical composite cable via a normally-on pass-gate transistor can be used. Particularly, it is desirable to configure the power source line of the optical/electrical composite cable so as to cause an inverse current (leak) towards the device side and cause a power loss when the power source of the device is turned off and attain sufficient insulation in the off state.

In this case, this embodiment is explained in more detail. As is explained in the first embodiment, in the optical/electrical composite cable, it is supposed that the switches 14, 24 are turned ON when it is determined by the optical link control units 13, 23 that the connectors 10, 20 are properly connected to the corresponding devices and both of the power sources of the devices on the transmission side and reception side are turned on. Further, it is supposed that the devices A, C are set in the power-ON state and the device B is set in the power-OFF state.

In the optical/electrical composite cable connected to the input (left) side of the device A, since the reception-side connector 20 is connected to the device A and no device is connected to the transmission-side connector 10, the switches 14, 24 are not turned ON and are kept in the OFF state. Therefore, the optical/electrical composite cable connected to the input side of the device A is not driven.

In the optical/electrical composite cable connected between the devices A and B, since the transmission-side connector 10 is connected to the device A, the reception-side connector 20 is connected to the device B and the devices A and C are set in the ON state, both of the switches 14 and 24 are turned ON. Therefore, the optical/electrical composite cable connected between the devices A and B is driven. At this time, since the device B is set in the OFF state, but the device C is set in the ON state, the reception-side connector 20 of the optical/electrical composite cable connected between the devices A and B is indirectly connected to the device C that is set in the power-ON state via the optical/electrical composite cable connected between the devices B and C and the device B. Therefore, the optical/electrical composite cable connected between the devices A and B detects both of the power-ON state of the transmission-side electronic device A directly connected thereto and the power-ON state of the reception-side electronic device C indirectly connected thereto.

In the optical/electrical composite cable connected between the devices B and C, since the transmission-side connector 10 is connected to the device B, the reception-side connector 20 is connected to the device C and the devices A and C are set in the ON state, both of the switches 14 and 24 are turned ON. Therefore, the optical/electrical composite cable connected between the devices B and C is driven. At this time, since the device B is set in the OFF state, but the device A is set in the ON state, the transmission-side connector 10 of the optical/electrical composite cable connected between the devices B and C is indirectly connected to the device A that is set in the power-ON state via the optical/electrical composite cable connected between the devices A and B and the device B. Therefore, the optical/electrical composite cable connected between the devices B and C detects both of the power-ON state of the transmission-side electronic device A indirectly connected thereto and the power-ON state of the reception-side electronic device C directly connected thereto.

In the optical/electrical composite cable connected to the output (right) side of the device C, since the transmission-side connector 10 is connected to the device C and no device is connected to the reception-side connector 20, the switches 14, 24 are not turned ON and are kept in the OFF state. Therefore, the optical/electrical composite cable connected to the output side of the device C is not driven.

With the above configuration, for example, when the power sources of the devices A and C are set in the ON state and the power source of the device B is set in the OFF state (at the viewing time of moving pictures by means of the image playback apparatus, for example), an optical link from the device A to the device C can be operated and the operation of supplying electrical power to the optical reception unit and optical transmission unit connected to the device B can be performed via the devices A and C. That is, supply of electrical power to the optical wiring interface can be interrupted in a state other than the normal operation state of a data link. Further, at this time, connection abnormality (improperness) is detected in the optical/electrical composite cables (to which no devices are connected) arranged outside the devices A and C and electrical power is not supplied to the optical transmission unit and optical reception unit. Therefore, unnecessary power consumption and unnecessary deterioration of the optical/electrical composite cable can be prevented.

Thus, according to this embodiment, a plurality of large-capacity data devices can be connected with minimum necessary electrical power and connection link operations, unnecessary electrical power can be reduced and the data link life can be lengthened to the maximum. As a result, the effective operation of the high-definition video device can be attained and the effect of energy saving and resource saving can be attained.

### Third Embodiment

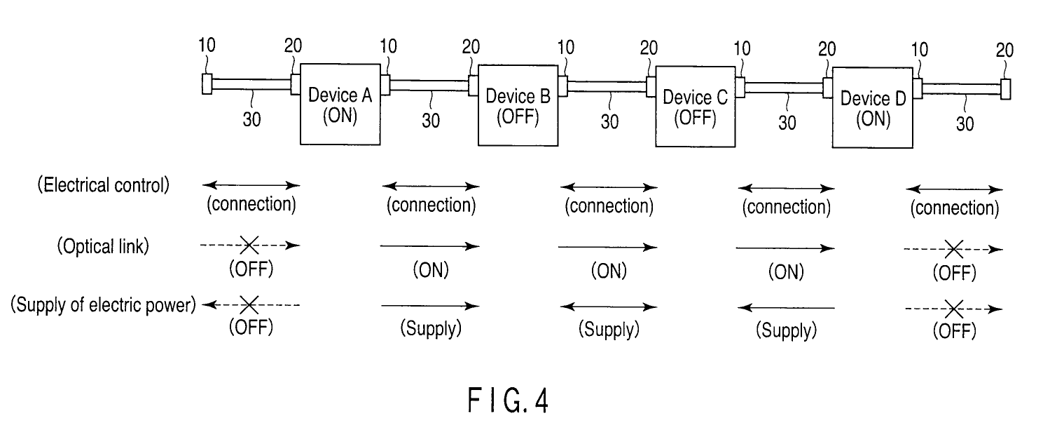

FIG. 4 is a block diagram showing an optical/electrical composite cable connection device according to a third embodiment of this invention and showing an example in which four data devices (A, B, C, D) are series-connected via optical/electrical composite cables. As examples of the respective devices, the device A is an image playback device or game device, the devices B, C are image recording devices and the device D is a display device, for example. In this example, it is supposed that image data is transmitted from the device A towards the device D.

Since the optical/electrical composite cables connected to the input port of the device A, between the devices A and B, between the devices B and C, between the devices C and D and to the output port of the device D function in the same manner as that of the second embodiment, the explanation thereof is omitted.

Also, in this embodiment, if it is supposed that the devices A, D are set in the power-ON state and the devices B, C are set in the power-OFF state, the optical/electrical composite cables connected to the input port of the device A and the output port of the device D are not driven and the optical/electrical composite cables connected between the devices A and B, between the devices B and C and between the devices C and D are driven for the same reason as that explained in the second embodiment.

Therefore, like the second embodiment, when the power sources of the devices A and D are set in the ON state and the power sources of the devices B and C are set in the OFF state (at the viewing time of moving pictures by means of the image playback apparatus, for example), an optical link from the device A to the device D can be operated and the operation of supplying electrical power to the optical reception unit and optical transmission unit connected to the devices B and C can be performed via the devices A and D. Further, at this time, connection abnormality is detected in the optical/electrical composite cables (to which no devices are connected) arranged outside the devices A and D and electrical power is not supplied to the optical transmission unit and optical reception unit. Therefore, unnecessary power consumption and unnecessary deterioration of the optical/electrical composite cable can be prevented.

Further, when the devices A and C are set in the ON state and the devices B and D are set in the OFF state, only the optical/electrical composite cables connected between the devices A and B and between the devices B and C are driven and an optical link between the devices A and C can be operated. Further, when the devices B and D are set in the ON state and the devices A and C are set in the OFF state, only the optical/electrical composite cables connected between the devices B and C and between the devices C and D are driven and an optical link between the devices B and D can be operated. That is, with the configuration formed by series-connecting a plurality of electronic devices by means of optical/electrical composite cables, only the optical/electrical composite cables connected between the devices that are set in the power-ON state can be driven.

Thus, according to this embodiment, only an optical/electrical composite cable of a portion required for a data link can be automatically driven, unnecessary electrical power can be reduced and the life of the optical interface can be effectively lengthened.

(Modification)

This invention is not limited to the above embodiments. For example, the above embodiments of this invention indicate several concrete examples, but they are given only as examples of the configuration and other means (circuits, structures, device configurations and the like) can be used as the individual constituents according to the objectives of this invention. Further, the configurations shown in the embodiments are provided only as examples and the embodiments can be combined and embodied.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical/electrical composite cable drive method for driving an optical/electrical composite cable in which a first connector having an optical transmission unit is connected to a second connector having an optical reception unit by an electrical wire and optical wiring line, the method comprising:
detecting a connection state of the first connector, a connection state of the second connector, a power supply state of a transmission-side electronic device that is coupled with the first connector and a power supply state of a reception-side electronic device that is coupled with the second connector; and
controlling supply of electrical power to the optical transmission unit and optical reception unit according to the detected connection states and power supply states of the respective electronic devices.

2. The method of claim 1, wherein electrical power is supplied to the optical transmission unit when the first connector is properly connected and a power-ON state of at least one of the transmission-side electronic devices is detected, and electrical power is supplied to the optical reception unit when the second connector is properly connected and a power-ON state of at least one of the reception-side electronic devices is detected to control the supply of electrical power.

3. The method of claim 1, wherein electrical power is supplied to the optical transmission unit and optical reception unit when both of the first and second connectors are properly connected and power-ON states of at least one of the transmission-side electronic devices and at least one of the reception-side electronic devices are detected to control the supply of electrical power.

4. The method of claim 3, wherein a power supply line connected to the transmission-side electronic device and reception-side electronic device is provided in part of the electrical wires, and electrical power is supplied to the optical transmission unit or the optical reception unit or both the optical transmission unit and optical reception unit the power supply line.

5. The method of claim 3, wherein supply of electrical power to the optical transmission unit and optical reception unit is permitted only when the first connector is connected to the data transmitter and the second connector is connected to the data receiver.

6. The method of claim 1, wherein said detecting includes: first detecting the connection state of the first connector and the connection state of the second connector, and then detecting the power supply state of the transmission-side electronic device directly or indirectly coupled with the first connector and the power supply state of the reception-side electronic device directly or indirectly coupled with the second connector.

7. The method of claim 1, wherein said detecting includes: first detecting the power supply state of the transmission-side electronic device directly or indirectly coupled with the first connector and the power supply state of the reception-side electronic device directly or indirectly coupled with the second connector, and then detecting the connection state of the first connector and the connection state of the second connector.

8. The method of claim 1, wherein the supply of electrical power to the optical transmission unit is not performed if the connection state of the first connector is abnormal or if a power ON state is not detected with respect to at least one of transmission-side electronic devices.

9. The method of claim 1, wherein the supply of electrical power to the optical reception unit is not performed if the connection state of the second connector is abnormal or if a power ON state is not detected with respect to at least one of reception-side electronic devices.

10. An optical/electrical composite cable comprising:
a first connector having an optical transmission unit;
a second connector having an optical reception unit;
an electrical wire connected between the first and second connectors;
an optical wiring line connected between the first and second connectors;
a state detection unit that detects a connection state of the first connector, a connection state of the second connector, a power supply state of a transmission-side electronic device that is coupled with the first connector and a power supply state of a reception-side electronic device that is coupled with the second connector; and
an electrical power supply control unit that controls supply of electrical power to the optical transmission unit and optical reception unit according to the states detected by the detection unit.

11. The cable of claim 10, wherein the detection unit includes a first detection unit that detects the connection state of the first connector and the power supply state of the transmission-side electronic device and a second detection unit that detects the connection state of the second connector and the power supply state of the reception-side electronic device,
and the control unit includes a first electrical power supply unit that supplies electrical power to the optical transmission unit when a correct connection state of the first connector and a power-ON state of at least one of the transmission-side electronic devices are detected by the first detection unit and a second electrical power supply unit that supplies electrical power to the optical reception unit when a correct connection state of the second connector and a power-ON state of at least one of the reception-side electronic devices are detected by the second detection unit.

12. The cable of claim 10, wherein the detection unit includes a first detection unit that detects the connection state of the first connector and the power supply state of the transmission-side electronic device and a second detection unit that detects the connection state of the second connector and the power supply state of the reception-side electronic device, and
the electrical power supply control unit supplies electrical power to the optical transmission unit and optical reception unit when a correct connection state of the first connector and a power-ON state of at least one of the transmission-side electronic devices are detected by the first detection unit and a correct connection state of the second connector and a power-ON state of at least one of the reception-side electronic devices are detected by the second detection unit.

13. The cable of claim 12, further comprising a power supply line connected to the transmission-side electronic device and reception-side electronic device in part of the electrical wire and switches connected between the power supply line and the optical transmission unit and optical reception unit, wherein the switches are controlled by the control unit.

14. The cable of claim 12, wherein supply of electrical power to the optical transmission unit and optical reception unit is permitted by the control unit only when the first connector is connected to the data transmitter and the second connector is connected to the data receiver.

15. An optical/electrical composite cable connection device comprising:
a data transmitter that outputs an electrical signal;
a data receiver that inputs an electrical signal;
at least one data relay unit inserted between the data transmitter and the data receiver; and
a plurality of optical/electrical composite cables that respectively connect adjacent ones of the data transmitter, data receiver and relay unit,
wherein the optical/electrical composite cable includes a first connector having an optical transmission unit, a second connector having an optical reception unit, an electrical wire connected between the first and second connector, an optical wiring line connected between the first and second connectors, a state detection unit that detects a connection state of the first connector, a connection state of the second connector, a power supply state of a transmission-side device that is coupled with the first connector and a power supply state of a reception-side device that is coupled with the second connector, and an electrical power supply control unit that controls supply of electrical power to the optical transmission unit and optical reception unit according to the states detected by the detection unit.

16. The connection device of claim 15, wherein the detection unit includes a first detection unit that detects the connection state of the first connector and the power supply state of the transmission-side device of the first connector and a second detection unit that detects the connection state of the second connector and the power supply state of the reception-side device of the second connector, and
the control unit includes a first electrical power supply unit that supplies electrical power to the optical transmission unit when a correct connection state of the first connector and a power-ON state of at least one of the transmission-side electronic devices are detected by the first detection unit and a second electrical power supply unit that supplies electrical power to the optical reception unit when a correct connection state of the second connector and a power-ON state of at least one of the reception-side electronic devices are detected by the second detection unit.

17. The connection device of claim 15, wherein the detection unit includes a first detection unit that detects the connection state of the first connector and the power supply state of the transmission-side electronic device that is coupled with the first connector and a second detection unit that detects the connection state of the second connector and the power supply state of the reception-side electronic device that is coupled with the second connector, and
the control unit supplies electrical power to the optical transmission unit and optical reception unit when a correct connection state of the first connector and a power-ON state of at least one of the transmission-side electronic devices are detected by the first detection unit and a correct connection state of the second connector and a power-ON state of at least one of the reception-side electronic devices are detected by the second detection unit.

18. The connection device of claim 17, further comprising a power supply line connected to the transmission-side device and reception-side device in part of the electrical wire and switches connected between the power supply line and the optical transmission unit and optical reception unit, wherein the switches are controlled by the control unit.

19. The connection device of claim 17, wherein electrical powers to the optical reception unit and optical transmission unit of the optical/electrical composite cable connected to the data relay unit are supplied from the data transmitter and data receiver to make a data link operable when correct connection states of the optical/electrical composite cable with respect to the respective devices and power-ON states of both of the data transmitter and data receiver are detected.

20. The connection device of claim 17, wherein a power source line of the optical/electrical composite cable and a power supply line of the data relay unit are cut off when the data relay unit is set in a power-OFF state.
